(19) United States
(12) Patent Application Publication
(10) Pub. No.: US 2007/0266871 A1
(43) Pub. Date: Nov. 22, 2007

(54) Diagnostic test media and methods for the manufacture thereof

(76) Inventors: Greta Wegner, Pompano Beach, FL (US); Natasha Popovich, Pompano Beach, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/435,295

(22) Filed: May 17, 2006

(51) Int. Cl. B41N 1/00

(52) U.S. Cl. 101/395

(57) ABSTRACT

The present disclosure relates to the manufacture of diagnostic test media used for measuring the concentration of analytes in a sample fluid. More specifically, the disclosure relates to using a method of microcontact printing or microtransfer molding for the manufacture of diagnostic test media.

### FIELD OF THE INVENTION

The invention relates to test media as well as systems and methods for manufacturing test media used to measure an analyte in a sample fluid. In particular, the present invention relates to systems and methods for depositing material onto a substrate as well as test media formed as a result of depositing material.

### BACKGROUND OF THE INVENTION

Meters and devices for measuring an analyte (e.g., glucose and cholesterol) in a sample of fluid often use disposable test media (e.g., strips, tapes, and discs). Test media manufacturers generally have several goals when developing methods for manufacturing disposable test media. These goals include finding methods that are quick and cost effective, while producing media that are reproduced on a large scale, consistently accurate, precise, and require a small sample volume.

Certain factors are important for achieving these goals, including resolution. The smaller the resolution of the electrode (e.g., micron-scale and nano-scale resolution), the smaller the surface area of the electrode. And the smaller the surface area of the electrode, the smaller the sample volume required. This is desirable with, for example, glucose monitoring for diabetics, where the patient must test his or her blood glucose multiple times a day. Smaller blood volume requirements allow the patient to obtain blood from areas with lower capillary densities than the fingers, such as the upper arm and forearm, which are less painful to lance.

The edges of the electrode are another factor. Smooth edges are an important feature of electrodes because the precision and accuracy of the measurement depend on the area of the electrode. If the edges of an electrode are irregular and vary from test medium to test medium, the area of the electrode, and therefore the measurement, will vary from test medium to test medium as well.

The methods currently used for manufacturing test media each have certain advantages and disadvantages. One method currently used is screen printing. Screen printing involves laying a mesh screen with an electrode pattern onto a substrate and then spreading an electroactive paste over the screen. The paste then extrudes through the screen onto the substrate in the pattern of the electrode. The substrate is heat treated to bake the electroactive paste onto the substrate, thereby creating the electrode. While screen printing is cost effective and allows for mass production of test media, it is difficult to obtain electrode patterns with small resolution and smooth edges. As such, reproducibility of the measurements is an issue with test media manufactured using this technique.

Another method currently used to manufacture test media is laser ablation. With the laser ablation technique, an electroactive material such as gold is sputtered in a thin film onto a substrate. A laser, typically a high-power excimer laser, then traces across the substrate and ablates the electroactive material, leaving an electrode pattern on the substrate. This technique produces electrodes with better resolution and smoother edges than with screen printing. On the other hand, laser ablation is expensive and relatively slow because it is a process where the laser must repeatedly pass over the substrate to carve out the electrode pattern. In addition, sputtered metal films commonly used in conjunction with laser ablation are expensive.

Accordingly, novel systems and methods for providing cost effective, small resolution, easily reproducible test media are desired that overcome the drawbacks of current test media and test media fabrication techniques.

### SUMMARY OF THE INVENTION

The claimed embodiments disclosed herein relate to the manufacture of test media using microcontact printing and/or microtransfer molding techniques. One embodiment is directed to a diagnostic test medium comprising at least one electrically insulating base layer, a stamped electroactive ink material on the base layer providing an electrode pattern of interest, and a reagent layer provided over at least a portion of the electrode pattern of interest.

In various embodiments, the medium may include one or more of the following additional features: wherein the electroactive ink includes an electroactive material selected from a group consisting of: palladium, gold, silver, platinum, copper, doped silicon, carbon, and conductive polymers; wherein the base layer is a thermoplastic material; wherein the base layer comprises polyethylene terephthalate (PET); wherein the electrode pattern of interest comprises an outline of a conductive structure selected from the group of: electrodes, electrical contacts, and conductive traces connecting one or more electrodes to one or more contacts; wherein the electrodes are selected from a group of: a cathode electrode region, an anode electrode region, and at least one fill-detect electrode region; wherein the electrical contacts are selected from a group of: a cathode electrode contact, an anode electrode contact, and at least one fill-detect electrode contact; wherein the electrical contacts comprise a first plurality of electrical contacts disposed closer to a proximal end of the test medium, and a second plurality of electrical contacts disposed closer to a distal end of the test strip; wherein each of the first plurality of electrical contacts connects to an electrode and wherein the second plurality of electrical contacts represents a code for presentation to a meter; wherein the reagent layer comprises chemical substances selected from the group of: enzymes, electrochemical mediators, buffers, polymeric binders, surfactants, enzyme stabilizers, and color indicators; wherein the enzyme in the reagent layer is selected from the group of: an enzyme having glucose as an enzymatic substrate and an enzyme having cholesterol as an enzymatic substrate; and wherein the reagent layer is stamped over at least a portion of the electrode pattern of interest.

Another embodiment is directed to a method for manufacturing test media comprising providing a stamp with an electrode pattern of interest, plasma treating a surface of the stamp, applying at least one electroactive ink to the stamp, and placing the stamp with the at least one electroactive ink in contact with a substrate such that the ink forms an electrode pattern on the substrate.

In various embodiments, the method may include one or more of the following additional features: wherein the stamp is prepared from a master with an inverse pattern of the electrode pattern of interest; wherein the master is made from a silicon wafer using photolithographic techniques; wherein the stamp is made from (poly)dimethylsiloxane; wherein applying at least one electroactive ink comprises applying an electroactive material selected from a group consisting of: palladium, gold, silver, platinum, copper, doped silicon, carbon, and conductive polymers; wherein the substrate comprises a polyethylene terephthalate (PET) material; further comprising drying the ink upon the substrate by baking the ink onto the substrate; further comprising drying the ink upon the substrate by sintering the ink onto the substrate; further comprising drying the ink upon the substrate by illuminating the ink with UV light; wherein providing a stamp with an electrode pattern of interest comprises forming a raised pattern projecting from a bottom surface of the stamp and wherein applying at least one electroactive ink to the stamp comprises applying ink only to the raised pattern of the stamp; wherein providing a stamp with an electrode pattern of interest comprises forming a grooved depression pattern configured to receive ink along a bottom surface of the stamp and wherein applying at least one electroactive ink to the stamp comprises applying ink only to the grooved depression pattern of the stamp; further comprising providing a second stamp with a reagent layer pattern of interest, applying at least one reagent mixture to the second stamp, and placing the stamp with the at least one mixture in contact with the substrate such that the reagent mixture forms a stamped reagent layer over at least a portion of the electrode pattern on the substrate; and wherein the reagent mixture comprises chemical substances selected from the group of: enzymes, electrochemical mediators, buffers, polymeric binders, surfactants, enzyme stabilizers, and color indicators; and wherein the enzyme in the reagent ink is selected from the group of: an enzyme having glucose as an enzymatic substrate and an enzyme having cholesterol as an enzymatic substrate.

Another embodiment is directed to a method for manufacturing test media comprising preparing a first stamp with an electrode pattern of interest, plasma treating a surface of the first stamp, contacting the first stamp with an electroactive ink, placing the stamp with the electroactive ink in contact with a substrate, preparing a second stamp with a reagent layer pattern of interest, contacting the second stamp with a reagent ink, and placing the second stamp with the reagent ink in contact with the substrate stamped with the electroactive ink.

In various embodiments, the method may include one or more of the following additional features: wherein the first stamp includes a conductive electrode pattern provided by a raised pattern projecting from a bottom surface of the first stamp and wherein contacting the first stamp with electroactive ink comprises providing ink only along the raised pattern; wherein the first stamp includes a conductive electrode pattern provided by a grooved depression pattern configured to receive ink along a bottom surface of the first stamp and wherein contacting the first stamp with electroactive ink comprises providing ink only along the grooved depression pattern; wherein the first and second stamps comprise a repeated pattern comprised of individual test media patterns such that the application of the first and second stamps result in the formation of an array of test media; wherein the first and second stamps comprise a press on which is arranged a plurality of stamps with at least one side with a pattern of interest, the side with the pattern of interest facing away from the center of the device and wherein placing a stamp in contact with the substrate comprises moving the press in contact with the substrate; wherein the first and second stamps comprise a cylinder on which is arranged a plurality of stamps with the sides with the pattern of interest facing away from the body of the cylinder wherein placing a stamp in contact with the substrate comprises rolling the cylinder along the substrate; further comprising drying the electroactive ink upon the substrate by baking the ink onto the substrate; further comprising drying the electroactive ink upon the substrate by sintering the ink onto the substrate; and further comprising drying the electroactive ink upon the substrate by illuminating the ink with UV light.

Another embodiment is directed to a diagnostic test medium comprising at least one electrically insulating base layer, an electroactive material on the base layer providing an electrode pattern of interest, and a stamped reagent layer provided over at least a portion of the electrode pattern of interest.

In various embodiments, the medium may include one or more of the following additional features: wherein the electroactive material is selected from a group consisting of: palladium, gold, silver, platinum, copper, doped silicon, carbon, and conductive polymers; wherein the base layer is a thermoplastic material; wherein the base layer comprises polyethylene terephthalate (PET); wherein the electrode pattern of interest comprises an outline of a conductive structure selected from the group of: electrodes, electrical contacts, and conductive traces connecting one or more electrodes to one or more contacts; wherein the electrodes are selected from a group of: a cathode electrode region, an anode electrode region, and at least one fill-detect electrode region; wherein the electrical contacts are selected from a group of: a cathode electrode contact, an anode electrode contact, and at least one fill-detect electrode contact; wherein the electrical contacts comprise a first plurality of electrical contacts disposed closer to a proximal end of the test medium, and a second plurality of electrical contacts disposed closer to a distal end of the test strip; wherein each of the first plurality of electrical contacts connects to an electrode and wherein the second plurality of electrical contacts represents a code for presentation to a meter; wherein the stamped reagent layer comprises chemical substances selected from the group of: enzymes, electrochemical mediators, buffers, polymeric binders, surfactants, enzyme stabilizers, and color indicators; and wherein the enzyme in the stamped reagent layer is selected from the group of: an enzyme having glucose as an enzymatic substrate and an enzyme having cholesterol as an enzymatic substrate.

Another embodiment is directed to a method for manufacturing test media comprising providing at least one electrically insulating base layer, providing an electroactive material on the base layer to form an electrode pattern of interest, preparing a stamp with a reagent layer pattern of interest, contacting the stamp with a reagent ink mixture, and placing the stamp with the reagent ink in contact with the base layer such that a stamped reagent layer is formed over at least a portion of the electrode pattern of interest.

In various embodiments, the method may include one or more of the following additional features: wherein stamp comprises a repeated pattern comprised of individual reagent layer patterns such that placing the stamp in contact with the base layer results in the formation of an array of test media with applied reagent layers; wherein the stamp comprises a press on which is arranged a plurality of stamps with at least one side with a pattern of interest, the side with the pattern of interest facing away from the center of the device and wherein placing a stamp in contact with the base layer comprises moving the press in contact with the base layer; wherein the stamp comprises a cylinder on which is arranged a plurality of stamps with the pattern of interest facing away from the body of the cylinder and wherein placing a stamp in contact with the base layer comprises rolling the cylinder along the base layer.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and, together with the description, serve to explain the principles of the invention.

### BRIEF DESCRIPTION OF THE DRAWINGS

FIGS. 1A and 1B are illustrations of embodiments of meters that employ disposable test strips to measure the concentration of an analyte in a sample fluid.

FIG. 2 is a top view of one embodiment of test media, a disposable test strip.

FIG. 3 is a cross-sectional view of the test strip of FIG. 2, taken along line 2-2.

FIG. 4 is a top view of a multiple electrode array pattern for reproduction of test strips.

FIG. 5 is a side-view schematic illustration of a master with an inverse pattern of interest.

FIG. 6A is a side-view schematic illustration of a master with a PDMS stamp formed on top of the master.

FIG. 6B is the side-view schematic illustration of the stamp of FIG. 6A separated from the master of FIG. 6A, showing both the inverse pattern of the master and the complementary pattern of the stamp.

FIG. 7A is a side-view schematic illustration of the stamp of FIGS. 6A and 6B with ink contacting a substrate.

FIG. 7B is a side-view schematic of the substrate with the ink deposited from the contact with the stamp of FIG. 7A.

FIG. 8A is a side-view schematic illustration of a different stamp having ink provided within the recess pattern of the stamp and with the stamp contacting a substrate.

FIG. 8B is a side-view schematic illustration of the substrate with the ink deposited from the contact with the stamp of FIG. 8A.

FIG. 9 is a top view of a distal portion of a particular test strip illustrating conductive regions forming electrical contacts according to an embodiment of the present invention.

FIG. 10 is a top perspective view of a test strip inserted within a meter strip connector according to an embodiment of the present invention.

FIG. 11 is a top view schematic illustration of one embodiment wherein a plurality of stamps are mounted onto a roller.

FIG. 12 is a bottom-view schematic illustration of one embodiment wherein a plurality of stamps are mounted onto a rigid-back press.

FIG. 13 is a top view of a proximal portion of a contact printed carbon electrode according to an embodiment of the present invention.

FIG. 14 is a top view of a proximal portion of a contact printed gold electrode according to an embodiment of the present invention.

FIG. 15 is a top view of a magnified top view of a proximal portion of a contact printed reagent chemistry layer according to an embodiment of the present invention.

### DESCRIPTION OF THE EMBODIMENTS

Reference will now be made in detail to various embodiments of the invention, examples of which are illustrated in the accompanying drawings. Wherever possible, the same reference numbers will be used throughout the drawings to refer to the same or like parts.

Embodiments of the present invention relate to methods for manufacturing diagnostic test media using microcontact printing. Microcontact printing is a technique that has been used in the biotechnology industry for various purposes. To briefly summarize, the technique entails creating a stamp with a pattern of interest. In certain embodiments, the stamp is formed using a master with the inverse pattern of interest as a template. The stamp is then coated with an “ink” and stamped onto a substrate, depositing the “ink” onto the substrate in the pattern of interest.

It has been found that microcontact printing could be used to transfer a monolayer of alkanethiolates onto a gold or silver film to study, for example, wetting, adhesion, protein adsorption, and cell adhesion (Whitesides, et al., Ann. Rev. Biomed. Eng., 3:335 (2001)). It has also been found that microcontact printing could be used to transfer an ethanolic solution of catalytic ink to facilitate carbon nanotube growth on a silicon substrate (Nilsson and Schlapbach, Langmuir, 16:6877 (2000)). More recently, scientists have found microcontact printing can transfer proteins, dendrimers, and other biomolecules for producing, for example, protein and DNA microarrays (Inerowicz et al., Langmuir 28:5263 (2002); Hong et al, Bull. Korean Chem. Soc. 24:1197 (2003)).

Prior techniques of contact printing are primarily concerned with the application of Self Assembled Monolayers (SAMs) on a substrate surface that is usually comprised of gold or silver (see Zhao et al. J. Mater Chem., 1997, (7), 1069-1074). The application of SAMs to the target substrate layer occurs through a process of coating a stamp with a hexadecanethiol ink, after which, the inked stamp is brought into contact with the target gold or silver substrate layer. Through this contact, the sulfur end of the hydrocarbon chain is chemisorbed onto the surface through the formation of a stable thioether bond between alkanethiol molecule and underlying gold or silver film. The monolayer of hexadecanethiolate (CH₃(CH₂)₁₅S⁻) is further stabilized by Van der Waals forces between adjacent alkyl chains. Micrometer scale patterns (and sometimes even smaller) are formed by these processes, whereby, the SAM patterns provides a protective barrier over the metal layer it covers. Therefore, after a chemical etching process, the metal patterns protected by the SAM material will remain in the underlying stamped pattern of interest with the surrounding metal layers being removed.

The present disclosure uses a novel microcontact printing technique for the manufacture of diagnostic test media. The test media of the present disclosure may be used with a suitable test meter to detect or measure the concentration of one or more analytes. An exemplary electrochemical biosensor is described in U.S. Pat. No. 6,743,635 (the '635 patent) which is incorporated by reference herein in its entirety. The '635 patent describes an electrochemical biosensor used to measure glucose level in a blood sample. The electrochemical biosensor system is comprised of a test strip and a meter. The test strip includes a sample chamber, a working electrode, a counter electrode, and fill-detect electrodes. A reagent layer is disposed in the sample chamber. The reagent layer contains an enzyme specific for glucose, such as, glucose oxidase or glucose dehydrogenase, and a mediator, such as, potassium ferricyanide or ruthenium hexaamine.

In one exemplary measurement technique, when a user applies a blood sample to the sample chamber on the test strip, the reagents react with the glucose in the blood sample and the meter applies a voltage to the electrodes to cause redox reactions. The meter measures the resulting current that flows between the working and counter electrodes and calculates the glucose level based on the current measurements. As noted above, the ease of test media production as well as additional factors such as cost, a desire for size reduction, and a reproducible uniform electrode pattern and area, are all considerations addressed by the test media systems and methods of the current application.

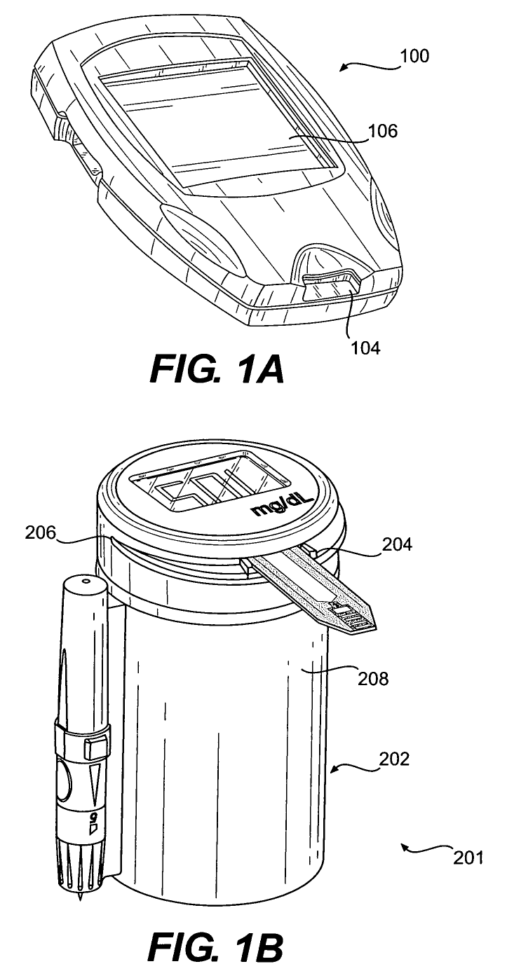

Examples of suitable meters are illustrated in FIGS. 1A and 1B. The one or more analytes may include a variety of different substances, which may be found in biological samples, such as blood, urine, tears, semen, feces, gastric fluid, bile, sweat, cerebrospinal fluid, saliva, vaginal fluid (including suspected amniotic fluid), culture media, and/or any other biologic sample. The one or more analytes may be found in nonbiologic samples as well, such as food, water, wine, pool chemistry, soil, gases, and/or any other nonbiologic sample. One of ordinary skill in the art will also appreciate that the present disclosure may be adapted to detect or measure the concentration of one or more analytes in nonbiologic samples as well.

FIG. 1A depicts a hand-held meter 100 including a display 106 and a test media insert port 104. FIG. 1B depicts an alternative meter 201, which is also disclosed in commonly owned co-pending U.S. patent application Ser. No. 11/352,209, filed Feb. 13, 2006, the entire contents of which are hereby incorporated by reference. Meter 201 includes a housing 202, an interface 204 for accepting test media in order to perform a diagnostic test, and a controller 206 configured to perform an algorithm for the underlying diagnostic test. The system also includes a container 208, having an opening covered and closed by the controller 206. The container 208 is operatively associated with the meter 201 and configured to contain test media compatible with the meter 201.

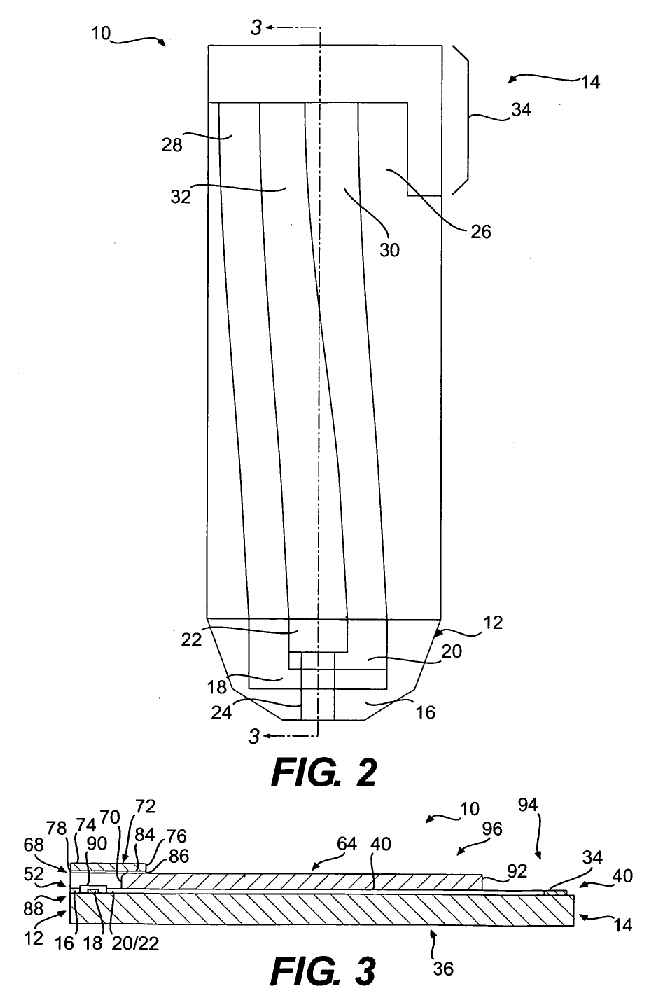

FIGS. 2, 3, and 4 depict one embodiment of diagnostic test media, a disposable test strip. Any test media may be suitable, however, including ribbons, tabs, or discs, for example. Moreover, the test media may facilitate a variety of testing modalities, such as electrochemical tests, photochemical tests, electrochemiluminescent tests, plain visual tests, and/or any other suitable testing modality.

FIG. 2 depicts a particular test strip configuration 10 contemplated for production via contact printing. As shown in FIGS. 2, the test strip 10 may be a flat strip with a proximal end 12, where the sample is applied, and a distal end 14, where the strip is inserted into the meter. The proximal end 12 may have a tapered configuration, as shown, in order to designate one end from the other, thereby distinguishing between a sample reception end and a meter insertion end.

The strip 10 includes a conductive pattern with electrodes formed at a proximal end 12, which then extend to corresponding conductive contacts close to the distal end 14. For example, in one embodiment, the conductive pattern forms a cathode electrode region 16, an anode electrode region 18, and first and second fill detect electrode regions 20 and 22 respectively, all of which are in contact with some portion of a sample cavity reception location 24. The four electrode regions 16, 18, 20, and 22, each lead to a corresponding conductive contact, 26, 28, 30, 32, for interfacing with a meter system. As will be described in more detail below, in one embodiment, a distal region 34 of strip 10 includes an additional contact pattern providing additional contacts for reception by a corresponding meter interface.

FIG. 3 is a cross-sectional view of a completely fabricated test strip, taken along line 2-2 in FIG. 3. As described in more detail below, the user.applies the blood sample to an opening in proximal end 12 of test strip 10. Further, other visual means, such as indicia, notches, contours or the like are possible.

As shown in FIG. 3, test strip 10 can have a generally layered construction upon final fabrication. Working upwardly from the bottom layer, test strip 10 can include a base layer 36 extending along the entire length of test strip 10. Base layer 36 can be formed from an electrically insulating material and has a thickness sufficient to provide structural support to test strip 10. For example, base layer 36 can be a polyester material, such as polyethylene terephthalate (PET).

According to an illustrative embodiment, a conductive layer 40 is disposed on base layer 36. As will be described in more detail below, the conductive layer 40 can be applied according to a novel process of contact printing and/or transfer molding. Conductive layer 40 defines the electrodes 16-22 described above, the plurality of electrical contacts 26-32 described above, and a plurality of conductive regions electrically connecting the electrodes to the electrical contacts.

The next layer in the illustrative test strip 10 is a spacer layer 64 disposed on conductive layer 40. The spacer layer 64 is composed of an electrically insulating material, such as polyester. The spacer layer 64 can be about 0.10 mm thick and cover portions of the electrodes 16-22, but in the illustrative embodiment does not cover a distal portion of electrical contacts 26-32. For example, spacer layer 64 can cover substantially all of conductive layer 40 thereon, from a line just proximal of contacts 26-32 all the way to proximal end 12, except for a slot 52 extending from proximal end 12. In this way, slot 52 can define an exposed portion of the cathode electrode region 16, an exposed portion of anode region 18, and an exposed portion of electrodes 20-22.

A cover 72, having a proximal end 74 and a distal end 76, can be attached to spacer layer 64 via an adhesive layer 78. Cover 72 can be composed of an electrically insulating material, such as polyester, and can have a thickness of about 0.075 mm. Additionally, the cover 72 can be transparent.

Adhesive layer 78 can include a polyacrylic or other adhesive and have a thickness of about 0.02 mm. Adhesive layer 78 can consist of sections disposed on spacer 64 on opposite sides of slot 52. A break 84 in adhesive layer 78 extends from the distal end 70 of slot 52 to an opening 86. Cover 72 can be disposed on adhesive layer 78 such that its proximal end 74 is aligned with proximal end 12 and its distal end 76 is aligned with opening 86. In this way, cover 72 covers slot 52 and break 84. In another arrangement, opening 86 can be replaced by a hole that is formed in cover 72 itself. Such a hole in the actual cover 72 provides a vent pathway to allow air in the chamber to be displaced by the fluid sample.

Slot 52, together with base layer 36 and cover 72, defines a sample chamber 88 in test strip 10 for receiving a blood sample for measurement in the illustrative embodiment. Proximal end 12 of slot 52 defines a first opening in sample chamber 88, through which the blood sample is introduced into sample chamber 88. Slot 52 is dimensioned such that a blood sample applied to its proximal end 68 is drawn into and held in sample chamber 88 by capillary action, with break 84 venting sample chamber 88 through opening 86, as the blood sample enters. Moreover, slot 52 can advantageously be dimensioned so that the blood sample that enters sample chamber 88 by capillary action is about 1 micro-liter or less. For example, slot 52 can have a length (i.e., from proximal end 12 to distal end 70) of about 0.140 inches, a width of about 0.060 inches, and a height (which can be substantially defined by the thickness of spacer layer 64) of about 0.005 inches. Other dimensions could be used, however. As noted above, in another arrangement the opening 86 can be replaced by a hole that is formed in cover 72 itself. In such an arrangement, the hole in cover 72 allows for a fluid sample to be drawn into the sample chamber 88 via capillary action in the same manner as that resulting from break 84.

A reagent layer 90 is disposed in sample chamber 88. In the illustrative embodiment, reagent layer 90 covers at least exposed portion of the cathode electrode region 16. Further according to the illustrative embodiment, reagent layer 90 also at least contacts an exposed portion of the anode electrode region 28 and preferably fully covers the anode. Reagent layer 90 includes chemical constituents to enable the level of glucose or other analyte in the test fluid, such as a blood sample, to be determined electrochemically. Thus, reagent layer 90 can include an enzyme specific for glucose, such as glucose oxidase or dehydrogenase, and a mediator, such as potassium ferricyanide or ruthenium hexamine. Reagent layer 90 can also include other components, such as buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485).

With these chemical constituents, reagent layer 90 reacts with glucose in the blood sample in the following way. The glucose oxidase initiates a reaction that oxidizes the glucose to gluconic acid and reduces the ferricyanide to ferrocyanide. When an appropriate voltage is applied to the cathode electrode region 16, relative to anode electrode region 18, the ferrocyanide is oxidized to ferricyanide, thereby generating a current that is related to the glucose concentration in the blood sample.

As depicted in FIG. 3, the arrangement of the various layers in illustrative test strip 10 can result in test strip 10 having different thicknesses in different sections. In particular, among the layers above base layer 36, much of the thickness of test strip 10 can come from the thickness of spacer 64. Thus, the edge of spacer 64 that is closest to distal end 14 can define a shoulder 92 in test strip 10. Shoulder 92 can define a thin section 94 of test strip 10, extending between shoulder 92 and distal end 14, and a thick section 96, extending between shoulder 92 and proximal end 12. The elements of test strip 10 used to electrically connect it to the meter, namely, electrical contacts 26-32, can all be located in thin section 94. Accordingly, the connector in the meter can be sized and configured to receive thin section 94 but not thick section 96, as described in more detail below. This can beneficially cue the user to insert the correct end, i.e., distal end 14 in thin section 94, and can prevent the user from inserting the wrong end, i.e., proximal end 12 in thick section 96, into the meter.

Although FIGS. 2 and 3 illustrate an illustrative embodiment of test strip 10, other configurations, chemical compositions and electrode arrangements could be used.

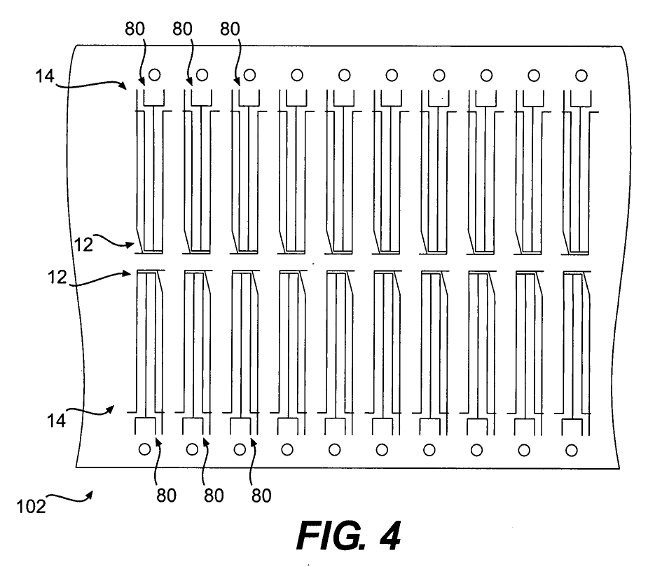

FIG. 4 shows a series of traces 80 for an individual test strip formed in a substrate material coated with a conductive layer. Traces 80, formed in the exemplary embodiment by contact printing and/or transfer molding techniques, partially form the conductive layers of two rows of ten test strips as shown. In the exemplary embodiment depicted, proximal ends 12 of the two rows of test strips are in juxtaposition in the center of a reel 102. The distal ends 14 of the test strips are arranged at the periphery of reel 102. It is also contemplated that the proximal ends 12 and distal ends 14 of the test strips can be arranged in the center of reel 102. Alternatively, the two distal ends 14 of the test strips can be arranged in the center of reel 102. The lateral spacing of the test strips is designed to allow a single cut to separate two adjacent test strips. The separation of the test strip from reel 102 can electrically isolate one or more conductive components of the separated test strip 10.

As depicted in FIG. 4, trace 80 for an individual test strip forms a plurality of conductive components; e.g., electrodes, conduction regions and electrode contacts. As will be described below, trace 80 may be comprised of a conductive pattern formed through a process of contact printing through the use of a prefabricated stamp. In embodiments where the final product test media requires a chemistry reagent, the reagent will be applied and formed after the formation of the conductive pattern such that at least a portion of the applied reagent covers at least one of the electrodes formed by the conductive pattern.

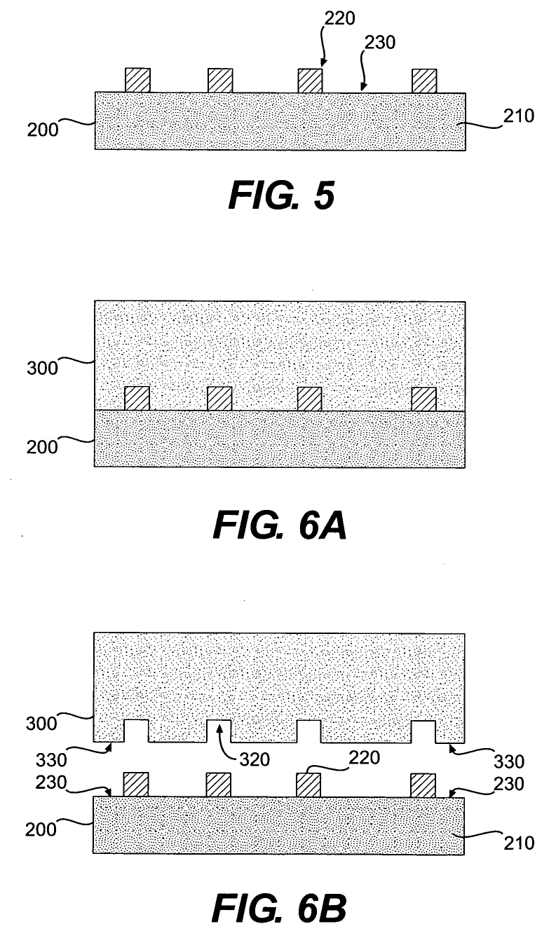

To manufacture the test media using microcontact printing, in certain embodiments, a master may be created and patterned by standard lithography procedures known to one of ordinary skill in the art. In short, photoresist (either negative or positive) is applied to a silicon wafer, although any suitable material may be used. Then a mask with the pattern of interest is placed on top of the wafer. The photoresist is then exposed, which, depending on whether it is negative or positive photoresist, will either polymerize or degrade the exposed regions of photoresist. (Alternatively, instead of using a mask, a laser may be used to selectively expose a desired pattern directly onto the photoresist.) The mask (if applicable) is then removed, and the unreacted photoresist is washed or etched away. FIG. 5 is a schematic illustration of an embodiment of a resulting master 200 to be used for casting an electrode stamp-the silicon wafer 210 with a raised pattern 220 outlining the borders of the electrode due to the leftover photoresist and an indented pattern 230, corresponding to the electrode area. One of ordinary skill in the art will recognize that the master pattern will contain the inverse of the actual pattern formed on the stamp.

In certain embodiments, the stamp is then fabricated using the master as a template. To prevent the stamp from adhering to the master, the master may be treated be gas phase silanization, plasma flourination, or other suitable techniques. The stamp may be made from (poly)dimethylsiloxane (“PDMS”), but any suitable material may be used. When using PDMS, PDMS precursors, including a curing agent, are mixed and put into a vacuum chamber to remove any oxygen bubbles, which may distort the stamp and affect the deposition of the ink. Afterwards, the mixed precursors are poured over the master. As an example, the PDMS can then be cured (e.g., at 60 degrees Celsius for one or more hours). After curing, the PDMS with the pattern of interest is peeled away from the master, thereby creating the stamp. The surface pattern features of the PDMS are the inverse of those present on the master.

As illustrated in FIG. 6A, the stamp 300 is formed over the master 200 and is therefore the inverse of the master 200. Thus, as shown in FIG. 6B, the raised pattern 220 of the master 200 creates the indented pattern 320 of the stamp 300. And the indented pattern 230 of the master 200 creates the raised pattern 330 of the stamp 300. In one embodiment, the raised pattern 330 of the stamp 300, therefore, corresponds to the desired electrode pattern to be fabricated via microcontact printing.

Other polymer materials suitable for curing over a master may be used for the stamp. Once formed into a patterned stamp, the polymer material should be reusable and should not react with a subsequently described “ink,” which may contain biomolecules. Likewise, the polymer stamp material should not interfere with the electroactive or chemical properties of the “ink.” Moreover, the material should not be too stiff to hinder removal from the master or ink transfer to the substrate.

After the stamp is created, a substance, also known as an “ink,” is applied to the stamp. The ink may be applied using any number of methods known to one of ordinary skill in the art. In certain embodiments, the ink may be applied by spraying or misting the ink onto the substrate. The ink may also be applied by dipping the stamp either completely or partially into the ink. Any excess ink may be removed using a blade, such as a razor, or other appliance for scraping the excess ink away. In other embodiments, the ink is applied directly by, for example, painting or spreading the ink onto the stamp using a brush, roller, or other suitable ink-applying utensil. As noted above, in embodiments where the final product test media requires a chemistry reagent, a reagent “ink” substance will be applied and formed after the application of an electroactive “ink” substance such that at least a portion of the applied reagent covers at least one of the electrodes formed by an electroactive “ink.”

Generally, the PDMS stamp surface will exhibit hydrophobic properties. This may hinder the transfer of the ink to the underlying substrate, depending on the type of ink used. Therefore, before use, the PDMS stamp can be treated with an oxygen plasma to create a hydrophilic surface. This will increase the propensity of the ink material to transfer it from the stamp to a surface to be printed, as well as the ink to more uniformly coat the stamp. Any plasma treatment device that is commercially available may be used to treat the stamp (e.g., Harrick Plasma bench top plasma cleaner, PVA TePla Plasma Pen, and ScanArc Plasma Technologies treaters). For purposes of this application, after this plasma process, the stamp is considered to be “plasma treated.”

The “ink” is the material that will be applied to a substrate material through microcontact printing, which will form the underlying conductive layer 40, described above. As described above, prior art procedures used inks containing SAM precursors to print SAM structures containing, for example, hexadecanethiol. In the following systems and methods, the microcontact printing is different in that the applied ink is an electrically conductive material and not a SAM. In addition, a feature or features printed from the ink may form a multi-layer structure as opposed to a monolayer structure. Moreover, the substrate of interest may be a polymer (e.g., a polyethylene terephthalate (PET) material) and not a gold or silver layer as used in earlier techniques. Since the ink materials, and the preferred surface materials, differ from those described with regard to earlier microcontact printing techniques, the mechanism of attachment between the ink and printed substrate, and the mechanism of layer formation within as-printed features, are also necessarily different from those related to earlier techniques.

The ink for the electrode pattern may comprise a suitably transferable form of any electroactive substance, including palladium, gold, silver, carbon, platinum, copper, doped silicon, conductive polymers, and/or any other suitable electrode material. The ink may comprise a single electroactive substance, or may comprise a mixture of electroactive substances. The electroactive ink may also be a custom organometallic ink (e.g., available from Gwent Electronic Materials, Ltd.) created for a particular purpose or characteristic, such as, for example, preventing conglomeration, or for its heat-treating properties. The ink may be in any form that allows for transfer onto a substrate, including liquid, paste, or powder form. The use of the word “ink,” on its own, is not intended to impart or imply any particular method of application or formation of the “ink” material.

For example, the mechanism of attachment between the ink and the polymer substrate is based on a mechanism of physical adsorption of the ink upon the polymer substrate. In some embodiments, the substance within the ink that provides the conductive properties will need to be mixed with a polymeric agent. When used, the polymeric agent provides a mechanism of cross-linking that results in a curing of the ink substance that provides one aspect of the attachment mechanism.

In one embodiment, the ink materials need only consist of an electrically conductive material, such as conductive metal particles or carbon powder, provided in a liquid-paste consistency state. The conductive material can be provided in a liquid-paste consistency, with the desired viscosity level of the ink controlled as desired with the addition of known chemical substances, as would be apparent to one having ordinary skill in the art. The substance in which the conductive material is dispersed can be comprised of an organic medium. For example, organic binders based on cellulose material such as ethyl cellulose and hydroxyethyl cellulose, acrylic resins such as polybutylmethacrylate, polymethylmethacrylate, and polyethylmethacrylate, epoxy resin, phenol resin, alkyd resin, polyvinyl alcohol, polyvinyl butyral or the like; and organic solvents, for example, ester solvents such as butyl cellosolve acetate, butyl carbitol acetate, ether solvents such as butyl carbitol, ethyleneglycol and diethyleneglycol derivatives, toluene, xylene, mineral spirit, terpineol, and methanol, can be used.

In another aspect of this application, the chemical reagent layer described above, can be applied in the form of a stamped ink material. The ink for the reagent layer may be any chemical substance that, once printed, may be used to facilitate the detection of one or more analytes. The ink may include one or more enzymes (e.g., glucose oxidase, cholesterol oxidase). Furthermore, the ink may include other chemical substances such as electrochemical mediators (e.g., potassium ferricyanide, ruthenium hexaamine), buffers (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), surfactants (e.g., Triton X-100 and/or Surfynol 485), enzyme stabilizers, color indicators, and/or any other chemical substance needed to facilitate production of a suitable test reaction. In some embodiments, due to the properties of the chemistry solution, applying the chemistry solution via the printing processes described in this application does not require any plasma treatment of the stamp prior to printing.

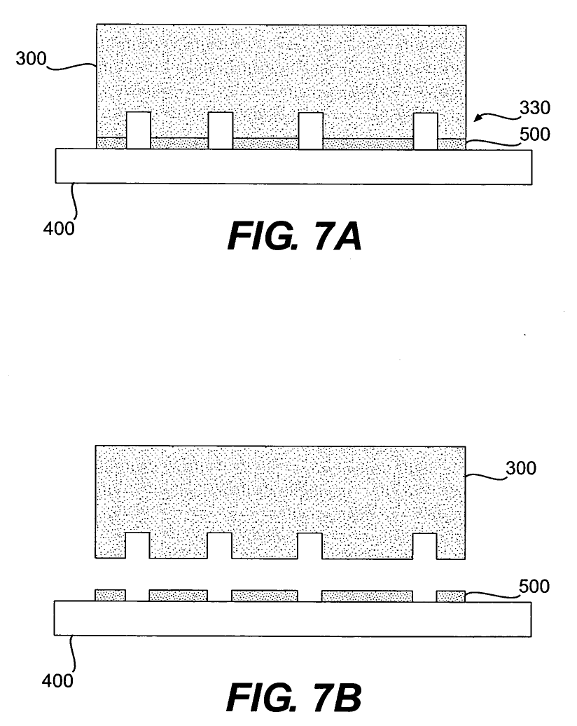

As shown in FIG. 7A, the inked stamp 300 is then brought into contact with a base layer, such as, for example, a substrate 400 to print desired features with ink 500; i.e. the substrate 400 is “stamped” with stamp 300. The substrate may be produced from a number of suitable material types, including a variety of different polymers (e.g., polythethylene terephthalate (PET), mentioned earlier, or any variations thereof), metals, and/or composite materials. In certain embodiments, the substrate is made from widely available, inexpensive material that is thermoplastic to facilitate ink application.

As illustrated in FIG. 7B, after contacting the stamp 300 with the substrate 400, the stamp 300 is removed, resulting in the deposition of ink 500 onto the substrate 400 in the configuration of the raised pattern 330 on the stamp 300. Contact between the inked stamp and the substrate occurs for a suitable period of time to allow transfer of a thin layer or layers of ink 500 onto the substrate. In some embodiments, which are different from earlier methods of depositing alkanethiol monolayers described above, which rely on a chemical bonding interaction (e.g., thiother bond between alkanethiol and substrate, Van Der Waals forces between alkanethiol carbon chains), the ink material attaches to the underlying substrate through a mechanical bond. Mechanical bonding can be strengthened by increasing the surface roughness of the underlying substrate layer upon which the ink is applied. The increased surface roughness increases the surface area along which the ink layer forms, thereby improving the mechanical bond.

In certain embodiments, printing the electroactive ink creates one or more electrode patterns. The one or more electrode patterns may include one or more electrodes (e.g. a cathode electrode, an anode electrode, a fill-detect cathode, and/or a fill-detect anode), one or more electrical contacts (e.g., extending from each of the electrodes), and/or one or more conductive traces connecting the one or more electrodes to the corresponding electrical contact. Other electrode patterns that may be deposited include a conductor that detects the contact with the meter and automatically turns the meter on.

Once the electroactive ink is deposited on the substrate, the ink on the substrate may be cured by baking, sintering, UV treatment, or by any number of suitable techniques. The curing conditions will vary depending on the properties of the ink applied. For example, in certain embodiments, a custom organometallic ink from Gwent Electronic Materials, Ltd. (GEM), is sintered at 500 degrees Fahrenheit. In the case of commercially available carbon and gold inks (GEM, Dupont), the material is cured at 60 degrees Celsius for 1-5 minutes.

As noted above, in certain embodiments, chemistry reagent layers may be deposited using this microcontact printing technique. Dilute solutions of the chemistry components may be used for the ink. The chemistry components may be added separately or simultaneously, and any appropriate drying technique may be used. In certain embodiments, the stamp deposits the chemistry layer in the sample well area of the test media.

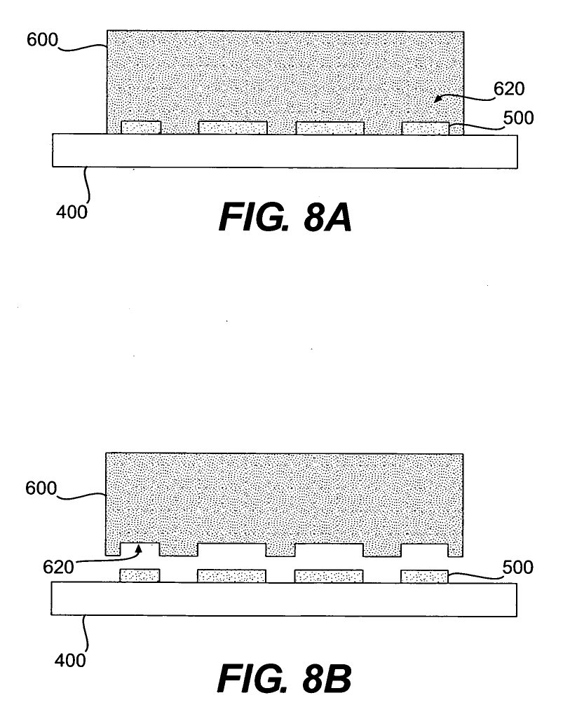

FIG. 8A depicts an additional system of test media formation. In the embodiment of FIGS. 8A-8B, a conductive pattern is applied to an underlying substrate through a mechanism of transfer molding, which is another variation of a microcontact printing. In a transfer molding technique, instead of using a raised pattern on the face of a stamp to imprint and transfer an ink substance, an ink substance is applied to indented depression features on a stamp. Thereafter, the inked stamp is placed in contact with the underlying substrate where the ink within the depression pattern is cured into a solid, after which the stamp in then peeled away (or otherwise removed) leaving the ink material in the pattern of interest. In other cases, the stamp may be removed prior to the curing of the deposited material.

For example, FIG. 8A depicts a stamp 600 that can be formed in any of the same methods described above with regard to microcontact printing. It is understood, however, that the desired pattern should be produced such that a negative depression pattern (as opposed to a raised positive protruding pattern) represents the pattern of interest. Accordingly, in FIG. 8A, the stamp 600 includes a series of troughs, or grooves, forming a depression pattern of interest 620. During a transfer molding procedure, an ink material 500 (which can constitute any of the ink materials described above) is applied to the grooves of the depression pattern 620. This is accomplished by placing the ink on bottom surface of the stamp 600 and removing any excess that remains along the raised pattern with a blade.

The stamp 600 is then placed in contact with a substrate 400 (which can constitute any of the materials described above, such as, for example, PET). The ink material 500 is then acted upon through a process that leaves the ink material in a solid form. For example, the ink material 500 can be subjected to a process of curing through illumination with ultra-violet light (UV illumination is not used when applying the chemistry reagent, however) or by the application of heat through either baking or sintering. In one embodiment, the application of a chemistry reagent is effectuated by employing a low temperature baking process to prevent denaturing of enzymes therein. As shown in FIG. 8B, after the ink is treated to produce a solid material, the stamp 600 is peeled away (or otherwise removed) from the substrate, leaving the patterned conductive ink structure 500 on the substrate 400. The stamp may also be removed prior to curing.

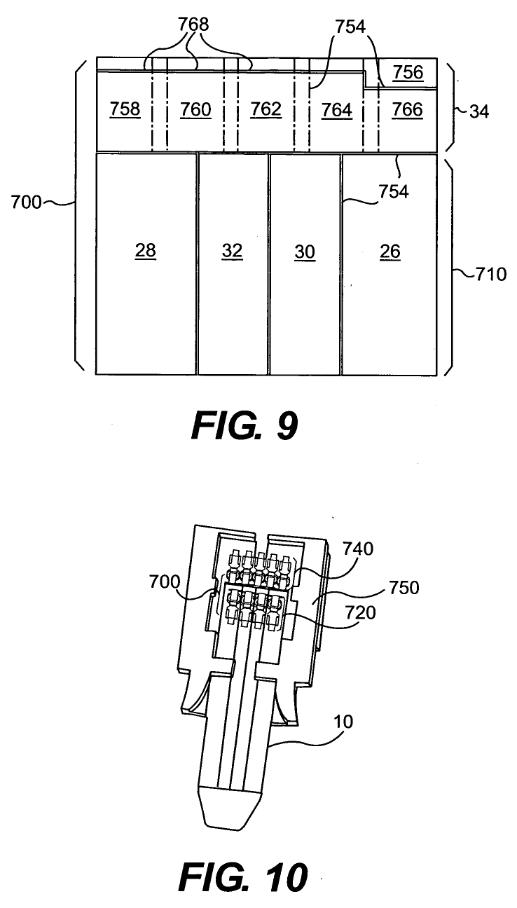

FIG. 9 depicts a top view of a distal portion of one exemplary conductive strip pattern for test media, according to one embodiment. In FIG. 9, the distal portion 700 of the illustrated test strip includes a first plurality of electric contacts 28, 32, 30, and 26 disposed closer to the proximal end of the test strip, and a second plurality of electric contacts 758, 760, 762, 764, and 766 disposed closer to the distal end of the test strip.

The conductive pattern formed on base layer 36, through one of the methods described above, extends along test strip to include the distal strip contact region 700. As illustrated in FIG. 9, distal strip contact region 700 is divided to form two distinct conductive regions, 34 and 710 respectively. Conductive region 710 is divided into four columns forming a first plurality of electrical strip contacts, labeled 28, 32, 30, and 26 respectively. The first plurality of electrical strip contacts are electrically connected to the plurality of measuring electrodes at the distal end of the test strip as explained above. It should be understood that the four contacts 26-32 are merely exemplary, and the system could include fewer or more electrical strip contacts corresponding to the number of measuring electrodes included in the system.

The first plurality of electrical strip contacts 26-32 are divided, for example, through breaks 754 formed through the underlying conductive pattern in the test strip 10. These breaks could be formed in the conductive pattern during the contact printing or transfer molding procedures, described above. In addition, other processes of forming conductive breaks by removing a conductor in the test strip 10 may be used as would be apparent to one having ordinary skill in the art. One break 754 divides conductive region 710 from conductive region 34 within distal strip contact region 700, and a further break 754 separates the upper right-hand portion of distal strip contact region 700 to form a notch region 756, as will be described more fully in detail below.

In FIG. 9, conductive region 34 is divided into five distinct regions outlining a second plurality of electrical strip contacts forming contacting pads 758, 760, 762, 764, and 766 respectively. The second plurality of electrical strip contacts forming contacting pads 758, 760, 762, 764, and 766, can be divided through the same process used to divide the first plurality of electrical strip contacts, 26-32, described above. As noted above, the conductive pattern on base layer 36, which at least in part forms the electrical strip contacts, can be applied to the top side of the strip, the bottom side of the strip, or a combination of both. The contacting pads 758, 760, 762, 764, and 766 are configured to be operatively connected to the second plurality of connector contacts 740 within meter connector 750 (see FIG. 10). Through this operative connection, the meter is presented with, and reads from the contacting pads, a particular code representing information signaling the meter to access data related to the underlying test strip 10. In addition, FIG. 4B depicts a pattern of breaks 768, isolating an outermost distal connecting end of the distal strip contact region 34.

As described in commonly owned co-pending U.S. patent application Ser. No. 11/181,778 filed Jul. 15, 2005 (the entire contents of which are hereby incorporated by reference), the contacting pads 758, 760, 762, 764, and 766 are configured to be operatively connected to the second plurality of connector contacts 740 within a meter connector 750 (see FIG. 10). Through this operative connection, the meter is presented with, and reads from the contacting pads, a particular code signaling the meter to access information related to a particular underlying test strip 10. The coded information may signal the meter to access data including, but not limited to, parameters indicating the particular test to be performed, parameters indicating connection to a test probe, parameters indicating connection to a check strip, calibration coefficients, temperature correction coefficients, pH correction coefficients, hematocrit correction data, and data for recognizing a particular test strip brand.

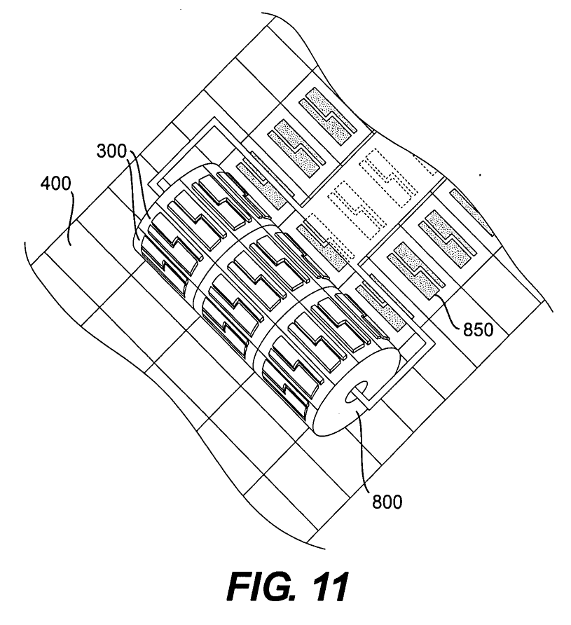

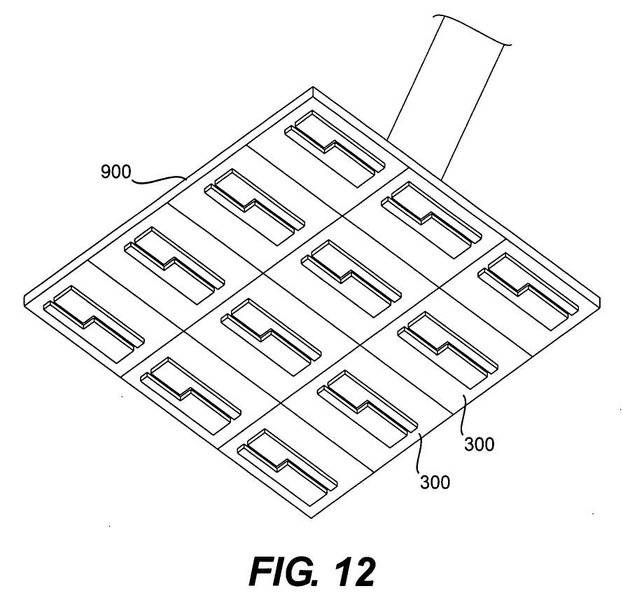

Further to the invention, the disclosed method may be normalized through various means to allow for mass production of test strips. As illustrated in FIG. 11, in certain embodiments, a plurality of stamps 300 are mounted on a roller 800. Ink may be applied to the roller 800, and the roller is rolled across a sheet of substrate 400, stamping the ink onto the substrate to produce a sheet of strips with the pattern of interest 850. Depending on the type of ink material used, the stamp or roller may require re-inking after each individual stamp contact. In other embodiments, however, the stamp structure could be inked and applied multiple times to different substrates while still maintaining a reservoir of ink such that multiple individual prints are possible before reapplying ink material. Similarly, as seen in FIG. 12, the plurality of stamps 300 may be mounted to a press 900 with a rigid back. Ink may be applied to the plurality of stamps 300, which are then pressed onto a sheet of substrate material. After printing, the strips with the pattern of interest may be separated from the sheet of substrate, thereby producing a plurality of strips at one time and promoting cost efficiency.

### EXAMPLES

The following portion of the application provides a few examples of conductive patterns and chemistry layers provided with the system and methods described above. Microcontact printed patterns according to embodiments of the invention may have features with spatial resolutions on the order of 1 micron or larger. As a non-limiting example, contact printed electrodes and chemistry layers for biosensors would, in some embodiments, have minimum spatial resolutions on the order of 25-1500 microns, and more preferably, on the range of between about 50-1000 microns.

In the systems and methods described throughout this application, the minimal spatial resolution of the underlying pattern formed is dependent on a number of factors. Optimization and modification of any of these factors can ultimately improve the dimensions of the printed features, as well as their resolution. For example, resolution and uniformity of the printed pattern features is dependent on the underlying quality and resolution of the features of the stamp, and ultimately the master from which the stamp is cast. Irregular features or edges on the surface features of the master (produced from ragged edges on the exposed photoresist) can limit the feature resolution that will be resolvable on the stamp and on the final print.

In addition, the rigidity of the stamp structure can affect the resulting pattern formed. For example, if the features of a polymer material forming the stamp are too soft, the stamp can compress too greatly upon contacting the substrate, which leads to deformation and undesired spreading of the applied ink material.

The solvent compatibility of the stamp is another factor that can affect spatial resolution. For example, organic solvents present on in ink may tend to expand the stamp, thereby also undesirably expanding the resulting stamped features.

As another example, the underlying particle size of the conductive substances in the ink limit the minimum spatial resolution achievable for a pattern. That is, the printed features can be no smaller than the individual particles present in the ink.

Contact Printing of Carbon and Gold Electrodes

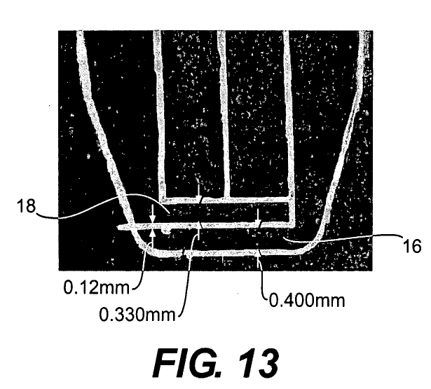

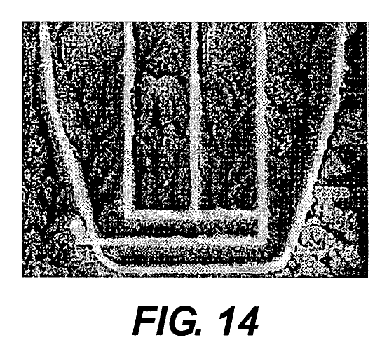

FIG. 13 is an enlarged top view of a proximal portion of a contact printed carbon electrode pattern. As seen in FIG. 13, the length along one portion of the cathode electrode pattern 16 formed through a carbon contact printing process is 0.400 mm. In addition, an exemplary length of a corresponding anode electrode region 18 is 0.330 mm, with the non-conductive pattern spaced there between exhibiting a length of about 0.12 mm. FIG. 14 depicts an enlarged top view of a proximal portion of a contact printed electrode pattern formed of a gold material.

As a non-limiting exemplary procedure, the gold and carbon electrodes were formed in one experiment as follows. A PDMS stamp was prepared using a silicone elastomer curing agent and base (Sylgard 184 silicone elastomer kit, available from Dow Corning Corporation) which were mixed together in a 1:10 ratio and poured evenly over patterned and surface treated silicon wafer masters (Premitec). The resulting PDMS material was then baked at 65 degrees F. for two hours. The cured PDMS material was removed from the masters and cut into individual stamps. A PDMS stamp was prepared and cut as described above. The stamp was treated with oxygen plasma (for about 30 seconds) prior to stamping. The stamps were then coated with a thin layer of either gold or carbon polymer paste (C2041206D2, C2000802D2, Gwent Electronic Materials Ltd.). A drop of hexane was used to reduce the viscosity of the paste materials to a desired level. Stamps were inked and then placed into contact with a polyester film substrate (Hostaphan W54B, available from Mitsubishi) for approximately 15 seconds. The PDMS stamp was then carefully removed to reveal the electrode features printed with ink. The printed electrode features were then baked at 65 degrees F. for approximately 30 minutes to form the final electrodes.

Contact Printing of Chemistry Layer

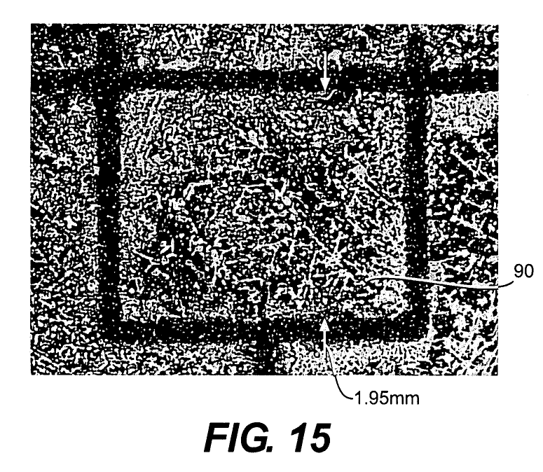

FIG. 15 is an example of a chemistry layer, such as layer 90 described above with regard to FIG. 3. As seen in FIG. 15, one portion of a length of the chemistry layer 90 exhibits a length of approximately 1.95 mm.

As a non-limiting exemplary procedure, the chemistry layer was formed in one experiment as follows. A PDMS stamp was prepared and cut as described above. The stamp was treated with oxygen plasma (for about 30 seconds) prior to stamping. An ink comprising the chemistry solution was applied to the stamp with a cotton swab and allowed to dry. An exemplary chemistry solution comprised: 0.05% Silwet, 0.05% Triton-x, 0.25% methocel F4M, 100 mM potassium phosphate buffer, 5% sucrose, 190 mM ruthenium hexaamine chloride, and 5000 u/ml glucose dehydrogenase, pH 7.25. The inked stamp was then applied to a 30 nm Au layer on a polyethylene terephthalate (PET) substrate for approximately 20 seconds and the stamp removed. The chemistry solution was then allowed to dry, thereby forming the final printed features.

One having ordinary skill in the art will appreciate that the present invention is adaptable for testing any analyte. Such possible analytes include, but are not limited to, glucose, cholesterol, lactate, blood urea nitrogen, TSH, T4, pharmaceuticals, and nontherapeutic drugs. It should be noted that the microcontact printing and microtransfer molding procedures described in this application can be used solely for the preparation of either the conductive electrode layer or the chemistry layer. Alternatively, the microcontact printing and microtransfer molding procedures described above can also be used in combination in order to provide test media with both a conductive layer and a chemistry layer thereon.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A diagnostic test medium comprising:
at least one electrically insulating base layer;
a stamped electroactive ink material on the base layer providing an electrode pattern of interest; and
a reagent layer provided over at least a portion of the electrode pattern of interest.

2. The test medium of claim 1, wherein the electroactive ink includes an electroactive material selected from a group consisting of: palladium, gold, silver, platinum, copper, doped silicon, carbon, and conductive polymers.

3. The test medium of claim 1, wherein the base layer is a thermoplastic material.

4. The test medium of claim 1, wherein the base layer comprises polyethylene terephthalate (PET).

5. The test medium of claim 1, wherein the electrode pattern of interest comprises an outline of a conductive structure selected from the group of: electrodes, electrical contacts, and conductive traces connecting one or more electrodes to one or more contacts.

6. The test medium of claim 5, wherein the electrodes are selected from a group of: a cathode electrode region, an anode electrode region, and at least one fill-detect electrode region.

7. The test medium of claim 6, wherein the electrical contacts are selected from a group of: a cathode electrode contact, an anode electrode contact, and at least one fill-detect electrode contact.

8. The test medium of claim 5, wherein the electrical contacts comprise a first plurality of electrical contacts disposed closer to a proximal end of the test medium, and a second plurality of electrical contacts disposed closer to a distal end of the test strip.

9. The test medium of claim 8, wherein each of the first plurality of electrical contacts connects to an electrode and wherein the second plurality of electrical contacts represents a code for presentation to a meter.

10. The test medium of claim 1, wherein the reagent layer comprises chemical substances selected from the group of: enzymes, electrochemical mediators, buffers, polymeric binders, surfactants, enzyme stabilizers, and color indicators.

11. The test medium of claim 10, wherein the enzyme in the reagent layer is selected from the group of: an enzyme having glucose as an enzymatic substrate and an enzyme having cholesterol as an enzymatic substrate.

12. The test medium of claim 1, wherein the reagent layer is stamped over at least a portion of the electrode pattern of interest.

13. A method for manufacturing test media, comprising:
providing a stamp with an electrode pattern of interest;
plasma treating a surface of the stamp;
applying at least one electroactive ink to the stamp; and
placing the stamp with the at least one electroactive ink in contact with a substrate such that the ink forms an electrode pattern on the substrate.

14. The method of claim 13, wherein the stamp is prepared from a master with an inverse pattern of the electrode pattern of interest.

15. The method of claim 14, wherein the master is made from a silicon wafer using photolithographic techniques.

16. The method of claim 13, wherein the stamp is made from (poly)dimethylsiloxane.

17. The method of claim 13, wherein applying at least one electroactive ink comprises applying an electroactive material selected from a group consisting of: palladium, gold, silver, platinum, copper, doped silicon, carbon, and conductive polymers.

18. The method of claim 13, wherein the substrate comprises a polyethylene terephthalate (PET) material.

19. The method of claim 13, further comprising drying the ink upon the substrate by baking the ink onto the substrate.

20. The method of claim 13, further comprising drying the ink upon the substrate by sintering the ink onto the substrate.

21. The method of claim 13, further comprising drying the ink upon the substrate by illuminating the ink with UV light.

22. The method of claim 13, wherein providing a stamp with an electrode pattern of interest comprises forming a raised pattern projecting from a bottom surface of the stamp and wherein applying at least one electroactive ink to the stamp comprises applying ink only to the raised pattern of the stamp.

23. The method of claim 13, wherein providing a stamp with an electrode pattern of interest comprises forming a grooved depression pattern configured to receive ink along a bottom surface of the stamp and wherein applying at least one electroactive ink to the stamp comprises applying ink only to the grooved depression pattern of the stamp.

24. The method of claim 13, further comprising providing a second stamp with a reagent layer pattern of interest;
applying at least one reagent mixture to the second stamp; and
placing the stamp with the at least one mixture in contact with the substrate such that the reagent mixture forms a stamped reagent layer over at least a portion of the electrode pattern on the substrate.

25. The method of claim 24, wherein the reagent mixture comprises chemical substances selected from the group of: enzymes, electrochemical mediators, buffers, polymeric binders, surfactants, enzyme stabilizers, and color indicators.

26. The method of claim 25, wherein the enzyme in the reagent ink is selected from the group of: an enzyme having glucose as an enzymatic substrate and an enzyme having cholesterol as an enzymatic substrate.

27. A method for manufacturing test media, comprising:
preparing a first stamp with an electrode pattern of interest;
plasma treating a surface of the first stamp;
contacting the first stamp with an electroactive ink;
placing the stamp with the electroactive ink in contact with a substrate;
preparing a second stamp with a reagent layer pattern of interest;
contacting the second stamp with a reagent ink; and
placing the second stamp with the reagent ink in contact with the substrate stamped with the electroactive ink.

28. The method of claim 27, wherein the first stamp includes a conductive electrode pattern provided by a raised pattern projecting from a bottom surface of the first stamp and wherein contacting the first stamp with electroactive ink comprises providing ink only along the raised pattern.

29. The method of claim 27, wherein the first stamp includes a conductive electrode pattern provided by a grooved depression pattern configured to receive ink along a bottom surface of the first stamp and wherein contacting the first stamp with electroactive ink comprises providing ink only along the grooved depression pattern.

30. The method of claim 27, wherein the first and second stamps comprise a repeated pattern comprised of individual test media patterns such that the application of the first and second stamps result in the formation of an array of test media.

31. The method of claim 30, wherein the first and second stamps comprise a press on which is arranged a plurality of stamps with at least one side with a pattern of interest, the side with the pattern of interest facing away from the center of the device and wherein placing a stamp in contact with the substrate comprises moving the press in contact with the substrate.

32. The method of claim 30, wherein the first and second stamps comprise a cylinder on which is arranged a plurality of stamps with the sides with the pattern of interest facing away from the body of the cylinder wherein placing a stamp in contact with the substrate comprises rolling the cylinder along the substrate.

33. The method of claim 27, further comprising drying the electroactive ink upon the substrate by baking the ink onto the substrate.

34. The method of claim 27, further comprising drying the electroactive ink upon the substrate by sintering the ink onto the substrate.

35. The method of claim 27, further comprising drying the electroactive ink upon the substrate by illuminating the ink with UV light.

36. A diagnostic test medium comprising:
at least one electrically insulating base layer;
an electroactive material on the base layer providing an electrode pattern of interest; and
a stamped reagent layer provided over at least a portion of the electrode pattern of interest.

37. The test medium of claim 36, wherein the electroactive material is selected from a group consisting of: palladium, gold, silver, platinum, copper, doped silicon, carbon, and conductive polymers.

38. The test medium of claim 36, wherein the base layer is a thermoplastic material.

39. The test medium of claim 36, wherein the base layer comprises polyethylene terephthalate (PET).

40. The test medium of claim 36, wherein the electrode pattern of interest comprises an outline of a conductive structure selected from the group of: electrodes, electrical contacts, and conductive traces connecting one or more electrodes to one or more contacts.

41. The test medium of claim 40, wherein the electrodes are selected from a group of: a cathode electrode region, an anode electrode region, and at least one fill-detect electrode region.

42. The test medium of claim 41, wherein the electrical contacts are selected from a group of: a cathode electrode contact, an anode electrode contact, and at least one fill-detect electrode contact.

43. The test medium of claim 40, wherein the electrical contacts comprise a first plurality of electrical contacts disposed closer to a proximal end of the test medium, and a second plurality of electrical contacts disposed closer to a distal end of the test strip.

44. The test medium of claim 43, wherein each of the first plurality of electrical contacts connects to an electrode and wherein the second plurality of electrical contacts represents a code for presentation to a meter.

45. The test medium of claim 36, wherein the stamped reagent layer comprises chemical substances selected from the group of: enzymes, electrochemical mediators, buffers, polymeric binders, surfactants, enzyme stabilizers, and color indicators.

46. The test medium of claim 45, wherein the enzyme in the stamped reagent layer is selected from the group of: an enzyme having glucose as an enzymatic substrate and an enzyme having cholesterol as an enzymatic substrate.

47. A method for manufacturing test media, comprising:
providing at least one electrically insulating base layer;
providing an electroactive material on the base layer to form an electrode pattern of interest;
preparing a stamp with a reagent layer pattern of interest;
contacting the stamp with a reagent ink mixture; and
placing the stamp with the reagent ink in contact with the base layer such that a stamped reagent layer is formed over at least a portion of the electrode pattern of interest.

48. The method of claim 47, wherein stamp comprises a repeated pattern comprised of individual reagent layer patterns such that placing the stamp in contact with the base layer results in the formation of an array of test media with applied reagent layers.

49. The method of claim 48, wherein the stamp comprises a press on which is arranged a plurality of stamps with at least one side with a pattern of interest, the side with the pattern of interest facing away from the center of the device and wherein placing a stamp in contact with the base layer comprises moving the press in contact with the base layer.

50. The method of claim 48, wherein the stamp comprises a cylinder on which is arranged a plurality of stamps with the pattern of interest facing away from the body of the cylinder and wherein placing a stamp in contact with the base layer comprises rolling the cylinder along the base layer.
